(19) United States
(12) Patent Application Publication
(10) Pub. No.: US 2015/0007111 A1
(43) Pub. Date: Jan. 1, 2015

(54) INTERACTIVE ALIGNMENT OF GRAPH AXES

(71) Applicant: Silicon Graphics International Corp., Fremont, CA (US)

(72) Inventor: Marc David Hansen, Morgan Hill, CA (US)

(21) Appl. No.: 13/931,788

(22) Filed: Jun. 28, 2013

(51) Int. Cl. G06F 3/0481; G06F 3/0484

(52) U.S. Cl. CPC G06F 3/04815; G06F 3/04842; G06F 3/04845
USPC 715/840; 715/848

(57) ABSTRACT

The present technology may provide data visualization with the capability to interactively select the orientation of one or more axis used to display data. Data to be visualized is accessed by a data visualization application. The data may be structured or unstructured, filtered and analyzed. The accessed data may be displayed through an interface of the visualization application for a user. The coordinate system for displaying the data may also be displayed. A user may orient an axis of the coordinate system by providing input within a graphics portion of an interface rather than navigating to a control button or other portion of the interface provided by the visualization application. The input may be associated with a particular axis. For example, to move a particular axis from its current position to a vertical position, the axis may be selected within the graphical portion of the interface using a cursor.

### BACKGROUND

1. Field of the Invention

The present invention relates to visualization of data. In particular, the present invention relates to adjusting graph axes alignment.

2. Description of the Prior Art

Visualization of data in three dimensional graphs can be helpful to understand the data. An example of a three dimensional graph is a plot of data on multiple axes, such as a horizontal, vertical, and another coming towards or away from the point of view of a viewer. Typically, visualization applications which display three dimensional data provide an interface having a graphical portion which provides data graphics and a control portion, such as a bar of control buttons. The control buttons may be implemented on a separate page from the graphical portion or otherwise separated from the graphical portion.

Many users desire to view their data from different angles in order to better understand data being visualized. However, it can be cumbersome to control the display of data from control portions of a visualization interface that are separate from a graphics portion. What is needed is an improved visualization interface for displaying data as desired by a user.

### SUMMARY

The present technology may provide data visualization with the capability to interactively select the orientation of one or more axis used to display data. Data to be visualized is accessed by a data visualization application. The data may be structured or unstructured, filtered and analyzed. The accessed data may be displayed through an interface of the visualization application for a user. The coordinate system for displaying the data may also be displayed. A user may orient an axis of the coordinate system by providing input within a graphics portion of an interface rather than navigating to a control button or other portion of the interface provided by the visualization application. The input may be associated with a particular axis. For example, to move a particular axis from its current position to a vertical position or other target orientation (for example, up, down, left, right, coming out of the screen, etc.), the axis may be selected within the graphical portion of the interface using a cursor.

An embodiment may perform a method for displaying data. A three dimensional image of a set of data and one or more axis may be provided within a graphical portion of an interface. A selection within the graphical portion of the interface may be received. The selection may be associated with an axis of the one or more axes. The image of the analyzed data and data axis may be modified based on the selection.

An embodiment may include a system for displaying data. The system may include a processor, a memory, and one or more modules stored in memory. The one or more modules may be executed by the processor to provide a three dimensional image of a set of data and one or more axes within a graphical portion of an interface, receive a selection within the graphical portion of the interface associated with an axis of the one or more axes, and modify the image of the analyzed data and data axis based on the selection.

### BRIEF DESCRIPTION OF THE DRAWINGS

FIG. 1 is a system for processing and visualizing data.

FIG. 2 is a method for processing and visualization data.

FIG. 3 is a method for providing a data visualization.

FIG. 4 is a visualization interface having a control bar.

FIG. 5 is another example of a visualization interface.

FIG. 6 is a visualization interface having rotated axes.

FIG. 7 provides a computing device for implementing the present technology.

### DETAILED DESCRIPTION

A visualization of data is provided with the capability to interactively select the orientation of one or more axes used to display data. Data to be visualized is accessed by a data visualization application. The data may be structured or unstructured, filtered and analyzed. The accessed data may be displayed through an interface of the visualization application for a user. The coordinate system for displaying the data may also be displayed. A user may orient an axis of the one or more axes by providing input within a graphics portion of an interface rather than navigating to a control button or other portion of the interface provided by the visualization application. The input may be associated with a particular axis. For example, to move a particular axis from its current position to a vertical position or other target orientation (for example, up, down, left, right, coming out of the screen, etc.), a particular axis or other portion of the interface may be selected within the graphical portion of the interface using a cursor.

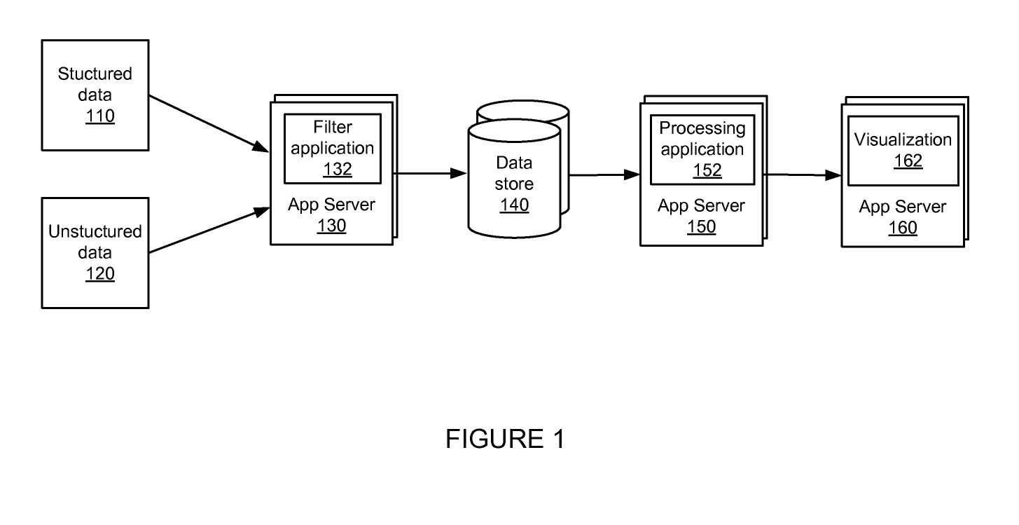

FIG. 1 is a system for processing and visualizing data. The system of FIG. 1 includes structured data 110, unstructured data 120, application servers 130, 150 and 160, and data store 140.

Structured data 110 (RDMS data) may include data items stored in tables. The structured data may be stored in a relational database, and may be formally described and organized according to a relational model. Structured data 110 may be data which can be managed using a relational database management system and may be accessed by application server 130.

Unstructured data may include data that does not include a predefined data model or does not fit into relational tables as structured data 110. Unstructured data may include text, dates, numbers, facts and other data, including email, media and documents. Unstructured data may also include lists or other data associated with web page clicks, shopping cart data, and other data. Unstructured data may be accessed by application server 130.

Application server 130 may include one or more servers which receive and access structured data 110 and unstructured data 120. Filter application 132 may be stored and executed on application server 130, and may be executed to ingest the structured and unstructured data. Filter application 132 may apply filters, intelligence, or other processes to select a subset of the data received and/or accessed.

Data store 140 may include one or more data stores which receive data which has been filtered by filter application 132. Data stores 140 may include SQL servers, NoSQL servers, and other servers. The data may be stored in these servers until they are accessed for processing.

Application server 150 may include one or more servers which receive and/or access data stored in data store 140. Processing application 152 may be stored on application server 150. When executed, processing application 152 may access filtered data from data store 140 and analyze the data for trends, patterns, a particular data of interest, or other data desired for reporting. For example, processing application 152 may be implemented by “Apache Hadoop” software, which is an open source software application that provides a distributed application for analyzing data.

Once data is analyzed, visualization program 162 located on application server 160 may report the data to a user. The data may be provided in many forms, such as reports, visualizations, and other formats. For example, visualization application 162 may provide data in a three dimensional graphical visualization format. In some embodiments, processing application 152 and visualization module 162 may be implemented as part of a client server tool set for extracting data, mining data with analytical algorithms, and providing interactive visualization input.

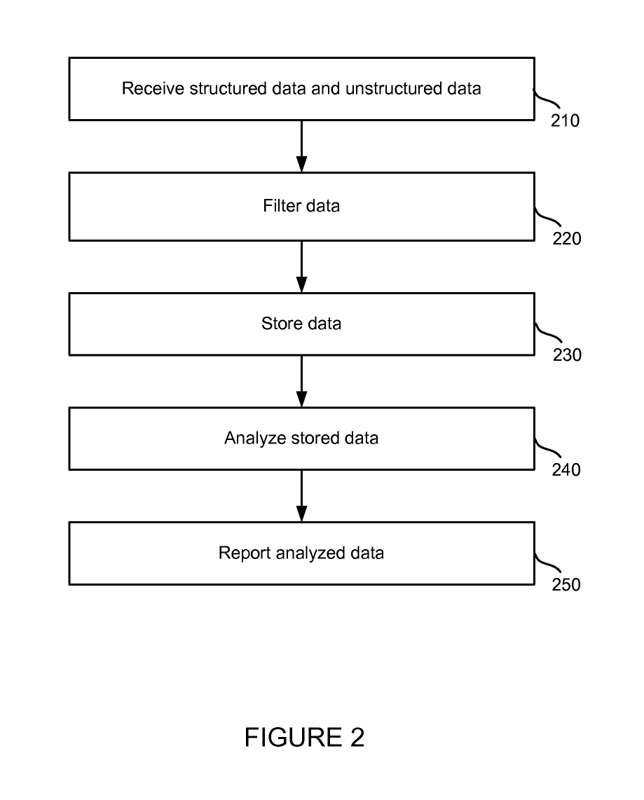

FIG. 2 is a method for analyzing and reporting data. The method of FIG. 2 may be performed by the system of FIG. 1. First, structured data and unstructured data may be received at step 210. The data may be received by filter application 132 on application server 130. The received data may be filtered at step 220. Filter application 132 may filter the data by time sampling, applying intelligence, and other methods to result in a subset of the entire set of the received data.

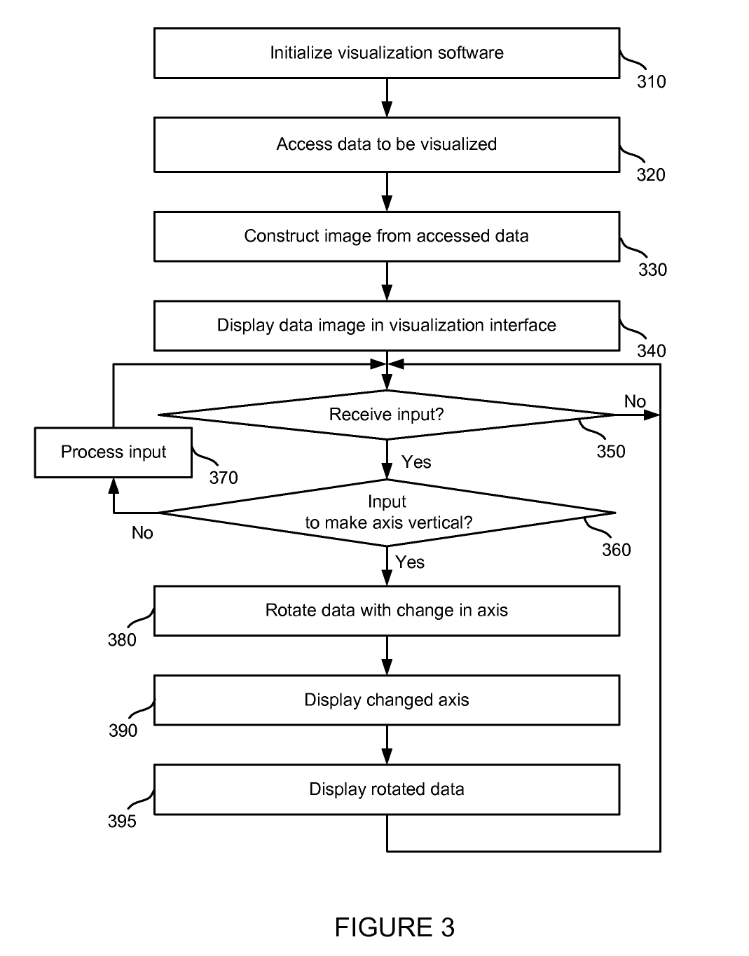

Filtered data may be stored at step 230. The data may be stored based on the type of data it is. For example, structured data may be stored in a SQL database and unstructured data may be stored in a NoSQL database. The stored data may be analyzed at step 240. Analyzing the data may include looking for trends, patterns, or otherwise processing the stored data to determine a subset of data to report to a user. Analyzing the data may be performed by processing application 152 on application server 150. Once the stored data is analyzed, the data can be reported at step 250. The data may be reported through an interactive visualization, reports, or other methods that may be useful to a user. The visualization may present a three dimensional graph of data and allow the coordinate system axis to be manipulated by a user. Step 250 is discussed in more detail with respect to FIG. 3.

FIG. 3 is a method for providing a visualization of data. The method of FIG. 3 may provide more detail for step 250 of the method of FIG. 2. In embodiments, visualization application 162 may perform the steps of FIG. 3. The visualization application 162 may extract stored data, mine data for desired information, and provide an interaction visualization of the data.

First, visualization software is initialized at step 310. Initializing the data may include executing the software, identifying what data to retrieve, and other configurations of the software. Data to be visualized may be accessed at step 320. The data may be accessed locally or remotely, for example from data store 140. An image from the accessed data is then constructed for display at step 330. The image for display may for example be constructed in a three dimensional scatter plot, having an x, y and z axis, or some other format.

The data image is displayed in a visualization interface at step 340. In some embodiments, a visualization interface may include a graphics portion and a control portion. The graphics portion may include the data displayed within a coordinate system. A control portion may include one or more interface buttons and other selectable objects for controlling and configuring the display in the graphical portion. The control portion may be implemented on a separate page or window than the graphical portion, or may otherwise be implemented separately from the graphical portion.

A determination is made as to whether input is received at step 350. If input is not received, the method of FIG. 3 remains at step 315 until input is received. Once input is received, for example in the form of placing a cursor over an axis and receiving input of a mouse button click, a determination is made as to whether the input is a request to designate a selected axis as the vertical axis within a graphical portion of an interface at step 360. In some embodiments, the input to move a selected axis to be the new vertical axis may comprise of a selection of a particular axis. The input may be received within a graphical portion of a visualization interface, thereby avoiding requiring a user to navigate to a different portion of the interface, or different interface page, to provide input to manipulate the visualization.

The input may be associated with an axis of one of more axes displayed in the graphical portion of the interface. For example, using a peripheral device such as a computer mouse, a user may place a cursor on a particular axis and click a mouse button to select the axis. Selection of the axis may move the axis from its current position to another position automatically determined based on the selection of the axis, and the remainder of axis in the graphical portion to change in position as well based on their relationship with the selected axis. For example, the position of the selected axis may change by automatically being moved to a vertical position upon being selected. The position of the selected axis may change a predetermined amount in a predetermined direction, such as for example a predetermined amount towards a vertical direction. For example, if the predetermined amount was fifteen degrees and the axis was a horizontal axis, the axis may be the vertical axis after clicking the axis six times (for a ninety degree change). Though selection of an axis resulting in making the axis a vertical axis is discussed in the method of FIG. 3, different movements of the axis and corresponding data in response to selection of an axis in the graphical portion of an interface are within the scope of the present invention.

If the input is to designate the selected axis as the vertical axis, data is rotated based on the changed axis at step 380. Rotation of the data may include determining how the data should be displayed in the graphical portion of the interface based on the change in axis orientation. The changed axis locations are provided in the interface at step 390. The changed axis may include the selected axis appearing as a vertical axis. The rotated data is then displayed in the interface at step 395. The method of FIG. 3 then returns to step 350. If no input is received to move an axis to a vertical axis at step 360, the input received as process is normal at step 370 and the method of FIG. 3 returns to step 350.

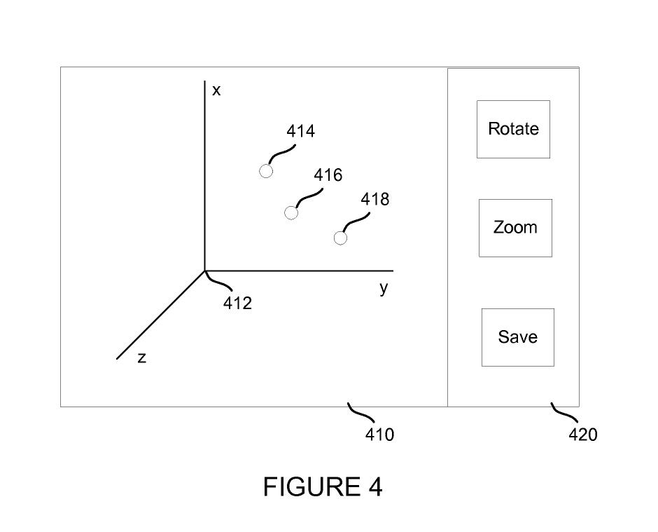

FIGS. 4-6 illustrate examples of a visualization interface for displaying three dimensional data. FIG. 4 provides a visualization interface 400. The visualization interface of FIG. 4 provides a graphics portion 410 and a control portion 420. The control portion 420 includes buttons for performing functions, such as for example a rotate button, zoom button and save button. In some embodiments, control portion may be implemented on a separate interface page than graphics portion 410. Graphics portion 410 includes a graphical coordinate system, such as x, y, z axes 412, and data such as data points 414, 416 and 418. In the interface of FIG. 4, the control of data manipulation within the graphics portion is managed by an interface within the control portion and separate from the graphics portion.

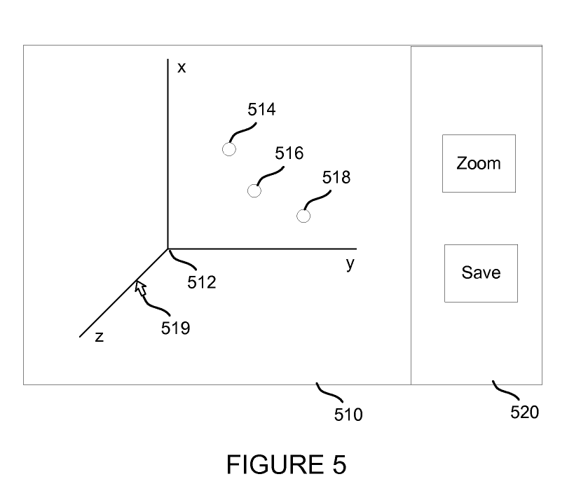

FIG. 5 is another example of a visualization interface. The interface of FIG. 5 includes an interface for providing input within a graphics portion of the visualization interface to manipulate an axis position. Within the graphics portion 510, a cursor 519 may be used to select the z portion of the axis 512. The selection may be made with other input devices as well.

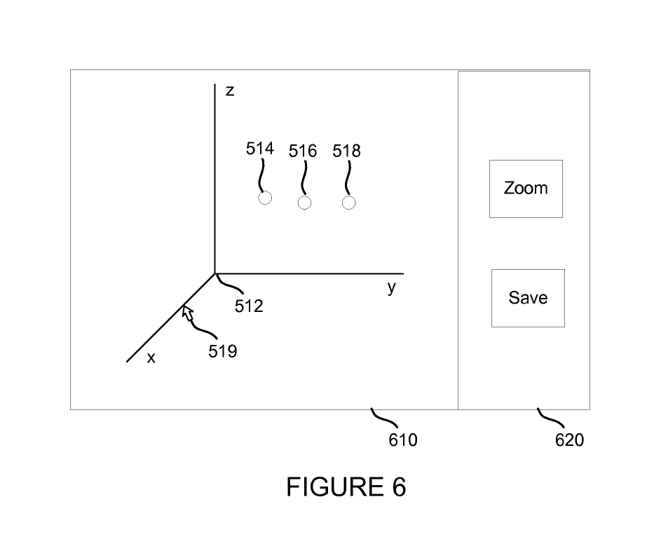

FIG. 6 illustrates a visualization interface having an axis position change. As shown in FIG. 6, the graphical portion of the interface illustrates that the z axis selected in the graphical portion 510 of FIG. 5 is now the vertical axis in the graphical portion of FIG. 6. The data points 514-518 have been rotated and/or translated to have different positions in view of the modified position of the axes.

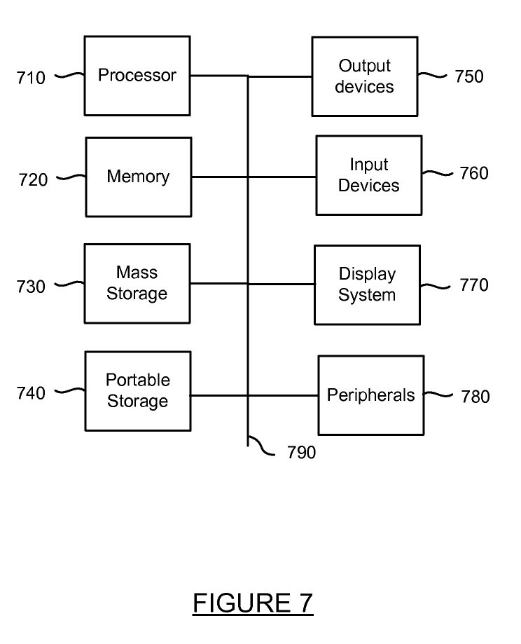

FIG. 7 provides a computing device for implementing the present technology. Computing device 700 may be used to implement devices such as for example application servers 130, 150 and 160 and data stores 140. FIG. 7 illustrates an exemplary computing system 700 that may be used to implement a computing device for use with the present technology. System 700 of FIG. 7 may be implemented in the contexts of the likes of client computer 210, servers that comprise services 230-250 and 270-280, application server 260, and data store 267. The computing system 700 of FIG. 7 includes one or more processors 710 and memory 720. Main memory 720 stores, in part, instructions and data for execution by processor 710. Main memory 720 can store the executable code when in operation. The system 700 of FIG. 7 further includes a mass storage device 730, portable storage medium drive(s) 740, output devices 750, user input devices 760, a graphics display 770, and peripheral devices 780.

The components shown in FIG. 7 are depicted as being connected via a single bus 790. However, the components may be connected through one or more data transport means. For example, processor unit 710 and main memory 720 may be connected via a local microprocessor bus, and the mass storage device 730, peripheral device(s) 780, portable storage device 740, and display system 770 may be connected via one or more input/output (I/O) buses.

Mass storage device 730, which may be implemented with a magnetic disk drive or an optical disk drive, is a non-volatile storage device for storing data and instructions for use by processor unit 710. Mass storage device 730 can store the system software for implementing embodiments of the present invention for purposes of loading that software into main memory 720.

Portable storage device 740 operates in conjunction with a portable non-volatile storage medium, such as a floppy disk, compact disk or Digital video disc, to input and output data and code to and from the computer system 700 of FIG. 7. The system software for implementing embodiments of the present invention may be stored on such a portable medium and input to the computer system 700 via the portable storage device 740.

Input devices 760 provide a portion of a user interface. Input devices 760 may include an alpha-numeric keypad, such as a keyboard, for inputting alpha-numeric and other information, or a pointing device, such as a mouse, a trackball, stylus, or cursor direction keys. Additionally, the system 700 as shown in FIG. 7 includes output devices 750. Examples of suitable output devices include speakers, printers, network interfaces, and monitors.

Display system 770 may include a liquid crystal display (LCD) or other suitable display device. Display system 770 receives textual and graphical information, and processes the information for output to the display device.

Peripherals 780 may include any type of computer support device to add additional functionality to the computer system. For example, peripheral device(s) 780 may include a modem or a router.

The components contained in the computer system 700 of FIG. 7 are those typically found in computer systems that may be suitable for use with embodiments of the present invention and are intended to represent a broad category of such computer components that are well known in the art. Thus, the computer system 700 of FIG. 7 can be a personal computer, hand held computing device, telephone, mobile computing device, workstation, server, minicomputer, mainframe computer, or any other computing device. The computer can also include different bus configurations, networked platforms, multi-processor platforms, etc. Various operating systems can be used including Unix, Linux, Windows, Macintosh OS, Palm OS, and other suitable operating systems.

The foregoing detailed description of the technology herein has been presented for purposes of illustration and description. It is not intended to be exhaustive or to limit the technology to the precise form disclosed. Many modifications and variations are possible in light of the above teaching. The described embodiments were chosen in order to best explain the principles of the technology and its practical application to thereby enable others skilled in the art to best utilize the technology in various embodiments and with various modifications as are suited to the particular use contemplated. It is intended that the scope of the technology be defined by the claims appended hereto.

What is claimed is:

1. A method for displaying data, comprising:
providing a three dimensional image of a set of data and one or more axis within a graphical portion of an interface;
receiving a selection within the graphical portion of the interface associated with an axis of the one or more axes; and
modifying the image of the analyzed data and data axis based on the selection.

2. The method of claim 1, wherein the interface includes a control portion, the control portion including selectable buttons for controlling display of the image

3. The method of claim 1, wherein the selection is received through use of a cursor.

4. The method of claim 1, wherein the image is changed to display the selected axis in a target orientation.

5. The method of claim 1, wherein the image is changed to move the selected axis a predetermined amount in a predetermined direction.

6. The method of claim 1, further comprising:
rotating data based on the selection; and
displaying rotated data in response to the selection.

7. The method of claim 1, wherein the one or more axis form an x,y,z coordinate system.

8. The method of claim 1, further comprising:
retrieving a set of data;
analyzing the set of data to select a sub-set of data to be provide through the interface, the analyzed sub-set of data including the set of data from which the three dimensional image is provided.

9. A computer readable storage medium having embodied thereon a program, the program being executable by a processor to perform a method for displaying data, the method comprising:
providing a three dimensional image of a set of data and one or more axis within a graphical portion of an interface;
receiving a selection within the graphical portion of the interface associated with an axis of the one or more axis; and
modifying the image of the analyzed data and data axis based on the selection.

10. The computer readable storage medium of claim 9, wherein the interface includes a control portion, the control portion including selectable buttons for controlling display of the image

11. The computer readable storage medium of claim 9, wherein the selection is received through use of a cursor.

12. The computer readable storage medium of claim 9, wherein the image is changed to display the selected axis as a vertical axis.

13. The computer readable storage medium of claim 9, wherein the image is changed to move the selected axis a pre-determined amount in a predetermined direction.

14. The computer readable storage medium of claim 9, the method further comprising:
rotating data based on the selection; and
displaying rotating data in response to the selection.

15. The computer readable storage medium of claim 9, wherein the one or more axis form an x,y,z coordinate system.

16. The computer readable storage medium of claim 9, the method further comprising:
retrieving a set of data;
analyzing the set of data to select a sub-set of data to be provide through the interface, the analyzed sub-set of data including the set of data from which the three dimensional image is provided.

17. A system for displaying data, comprising:
a processor;
memory;
one or more modules stored in memory and executed by the processor to provide a three dimensional image of a set of data and one or more axis within a graphical portion of an interface, receive a selection within the graphical portion of the interface associated with an axis of the one or more axis, and modify the image of the analyzed data and data axis based on the selection.

18. The system of claim 17, wherein the interface includes a control portion, the control portion including selectable buttons for controlling display of the image

19. The system of claim 17, wherein the selection is received through use of a cursor.

20. The system of claim 17, wherein the image is changed to display the selected axis as a vertical axis.

21. The system of claim 17, wherein the image is changed to move the selected axis a pre-determined amount in a predetermined direction.

22. The system of claim 17, the one or more modules further executable to rotate data based on the selection and display rotated data in response to the selection.

23. The system of claim 17, wherein the one or more axis form an x,y,z coordinate system.

24. The system of claim 17, the one or more modules further executable to retrieve a set of data and analyze the set of data to select a sub-set of data to be provide through the interface, the analyzed sub-set of data including the set of data from which the three dimensional image is provided.
